(19) United States
(12) Patent Application Publication
(10) Pub. No.: US 2018/0148566 A1
(43) Pub. Date: May 31, 2018

(54) RUBBER COMPOSITION CONTAINING SPECIALIZED SOYBEAN OIL AND TIRE WITH COMPONENT

(71) Applicant: The Goodyear Tire & Rubber Company, Akron, OH (US)

(72) Inventors: Stephan Rodewald, Canal Fulton, OH (US); George Jim Papakonstantopoulos, Medina, OH (US); Bruce Raymond Hahn, Hudson, OH (US)

(21) Appl. No.: 15/361,521

(22) Filed: Nov. 28, 2016

(51) Int. Cl. C08L 9/06

(52) U.S. Cl. CPC C08L 9/06; C08L 2205/06; C08L 2205/02

(57) ABSTRACT

The invention relates to a rubber composition comprised of at least one conjugated diene-based elastomer containing triglyceride based specialized soybean oil having a high mono-unsaturated oleic acid ester component and to a tire with a component thereof.

### FIELD OF THE INVENTION

This invention relates to a rubber composition comprised of at least one conjugated diene-based elastomer containing triglyceride based specialized soybean oil having a high mono-unsaturated oleic acid ester component and to a tire with a component thereof.

### BACKGROUND OF THE INVENTION

Rubber compositions are often desired for tire components where one or more of uncured rubber processability and cured rubber composition properties are promoted.

Various diene-based elastomers are sometimes blended with petroleum based oil to improve their uncured processing which may sometimes also improve various cured rubber properties.

Sometimes soybean oil has been suggested for blending with various diene-based elastomers instead of or in combination with petroleum based oil for such purposes. For example, and not intended to be limiting, see U.S. Pat. Nos. 6,448,318, 7,919,553, 8,100,157, 8,022,136 and 8,044,118 and U.S. Patent Application No. 2014/0155660.

Triglycerides are main constituents of plant derived oils such as soybean oil which are fatty acid esters formed from glycerol (a trihydric alcohol containing three hydroxyl groups) and thereby containing three fatty acid groups.

Soybean oil is comprised of mixed saturated, mono-unsaturated and polyunsaturated triglyceride esters of fatty acids. The unsaturated ester content of the soybean oil is understood to be conventionally comprised of a minor mono-unsaturated triglyceride ester content in a form of oleic acid based ester (e.g. about 20 to about 35 percent of the unsaturated fatty acid ester components of the soybean oil, or about 20 to about 30 percent of the saturated and unsaturated acid ester components), and therefore a major content of unsaturated esters of the soybean oil being comprised of about 65 to about 80 percent poly-unsaturated fatty acid esters containing primarily di-functional linoleic acid ester and tri-functional linolenic acid ester.

It is contemplated that a significant decrease in the unsaturation content of the soybean oil in a sense of a significant increase in the mono unsaturated acid ester component (increase in the oleic acid ester component) of the soybean oil with a corresponding decrease in the poly unsaturated acid ester component (decrease in the polyunsaturated linoleic and linolenic acid ester components) might have some effect on the properties of rubber compositions containing the specialized soybean oil which is the subject of this evaluation.

Accordingly, a specialized soybean oil containing a significantly reduced unsaturation content (resulting from a significantly increased mono-unsaturated oleic acid ester content) is desired to be evaluated for use with various diene-based elastomers. Such specialized soybean oil is to be obtained as a natural vegetable oil from a hybrid soybean plant.

In one embodiment, at least about 65, alternately about 75 to about 95, percent of the unsaturated fatty acid esters of the specialized soybean oil is comprised of mono-unsaturated oleic acid ester (wherein the combination of saturated and unsaturated fatty acids contain about 65 to about 90 percent of the mono-unsaturated oleic acid ester) and with the remainder of the unsaturated fatty acid esters being comprised of poly-unsaturated fatty acid esters.

For such evaluation, it is important to appreciate that the triglyceride ester based soybean oil is chemically differentiated from petroleum (hydrocarbon) based oils in a sense that such specialized soybean oil contains a significant degree of mono-unsaturation (from oleic acid) and is clearly not a linear or an aromatic petroleum based oil.

The chemical composition of soybean oil may be determined by gas chromatographic (GC) analysis according to ASTM D5974. For the gas chromatographic analysis (GC analysis), the triglycerides of the soybean oil are converted into fatty acid methyl esters by reflux in an acidic methanol-toluene azeotrope before the GC analysis. Gas chromatographic analysis of the fatty acid methyl esters shows the high degree of mono-unsaturation of the triglyceride ester based specialized soybean oil.

The triglyceride based specialized soybean oil thereby contains a high content of mono-unsaturated oleic fatty acid ester component of the triglyceride esters and minor content of di-unsaturated linoleic acid and tri-unsaturated linolenic acid ester component of the triglyceride compared to what is understood to be a more conventional soybean oil.

The challenge of combining such high mono-unsaturated triglyceride based specialized soybean oil for use as a rubber processing oil instead of and in contrast to petroleum based oil and more conventional soybean oil with diene based elastomers with reinforcing filler containing precipitated silica in an internal rubber mixer (e.g. Banbury™ mixer) is to be evaluated with results being unknown until such evaluation is undertaken.

In the description of this invention, the terms “compounded” “rubber compositions” and “compounds”, where used, refer to rubber compositions which have been compounded, or blended, with appropriate rubber compounding ingredients. The terms “rubber”, “polymer” and “elastomer” may be used interchangeably unless otherwise indicated. The amounts of materials are usually expressed in parts of material per 100 parts of rubber by weight (phr).

### SUMMARY AND PRACTICE OF THE INVENTION

In accordance with this invention, a rubber composition is provided comprised of, based on parts by weight per 100 parts by weight of elastomer (phr):

(A) at least one conjugated diene-based elastomer,

(B) from about 5 to about 60, alternately from about 10 to about 40, phr of triglyceride ester based specialized soybean oil where unsaturated fatty acid ester components thereof comprise a combination of mono-unsaturated oleic acid ester, di-unsaturated linoleic acid ester and tri-unsaturated linolenic acid ester components wherein said oleic acid ester component comprises at least 65 percent and alternately from about 75 to about 95 percent of said fatty acid ester components, and

(C) from about 30 to about 140, alternately from about 50 to about 120 phr of reinforcing filler comprised of:
(1) rubber reinforcing carbon black, or
(2) precipitated silica (amorphous silica), or
(3) combination of rubber reinforcing carbon black and precipitated silica (containing, for example, about 20 to about 99 weight percent of precipitated silica, alternately from about 55 to about 99 weight percent precipitated silica, for a silica-rich reinforcing filler),
wherein said precipitated silica is provided together with silica coupler (silica coupling agent) for said precipitated silica having a moiety reactive with hydroxyl groups (e.g. silanol groups) on said precipitated silica and another different moiety interactive with said diene-based elastomer(s).

In one embodiment, said high oleic acid based ester content specialized soybean oil contains a minimum of about 1 percent tri-functional linolenic acid based ester and typically in a range of from about 1.5 to about 5 percent of said linolenic acid based ester.

In one embodiment, because of inherent inconsistencies of compositions of various natural vegetable triglyceride oils, including for example, whether they contain 1.5 to about 3.5 percent of the tri-functional linolenic acid based ester of soybean oil, it is desired that the specialized soybean oil is exclusive of other vegetable triglyceride oils, including, for example, vegetable triglyceride oils which do not contain at least one percent linolenic acid ester.

In one embodiment, said specialized soybean oil is exclusive of plasticized starch containing soybean oil.

In one embodiment, a tire is provided having a component comprised of such rubber composition.

In one embodiment, a tire is provided having a tread comprised of such rubber composition.

It is important to appreciate that such triglyceride ester based specialized soybean oil is derived from a naturally occurring vegetable, namely soybeans.

The precipitated silica (synthetic amorphous precipitated silica) may be provided as:

(A) a precipitated silica hydrophobated by reaction in situ within the rubber composition with said silica coupling agent, or

(B) a pre-hydrophobated precipitated silica (pre-hydrophobated prior to its addition to the rubber composition comprised of having been hydrophobated by reaction of precipitated silica with said silica coupling agent to form a composite thereof prior to its addition to the rubber composition.

In one embodiment, where said precipitated silica is a pre-hydrophobated precipitated silica, additional silica coupler may be added to the rubber composition, if desired.

In one embodiment, where said precipitated silica is a pre-hydrophobated precipitated silica, additional precipitated silica (non-pre-hydrophobated precipitated silica) may be added to the rubber composition, if desired.

In one embodiment, the rubber composition is free of petroleum based rubber processing oil.

Representative examples of various diene-based elastomers are, for example, at least one of cis 1,4-polyisoprene, cis 1,4-polybutadiene, isoprene/butadiene, styrene/isoprene, styrene/butadiene and styrene/isoprene/butadiene elastomers. Additional examples of elastomers which may be used include 3,4-polyisoprene rubber, carboxylated rubber, silicon-coupled and tin coupled star-branched elastomers. Often desired rubber or elastomers are cis 1,4-polybutadiene, styrene/butadiene rubber and cis 1,4-polyisoprene rubber.

In one embodiment at least one of such diene-based elastomers may be a functionalized styrene/butadiene elastomer or functionalized cis 1,4-polybutadiene elastomer containing at least one functional group reactive with hydroxyl groups (e.g. reactive with silanol groups) contained on the precipitated silica reinforcing filler to aid in promoting precipitated silica reinforcement of the rubber composition. Such functional group may be comprised of at least one of amine, siloxy, carboxyl, hydroxyl groups, and thiol groups, which may include, for example, a combination of siloxy and thiol groups, as being functional groups which are reactive with hydroxyl groups (e.g. silanol groups) contained on precipitated silica. In one embodiment, the functionalized diene-based elastomer is at least one of styrene/butadiene rubber and cis 1,4-polybutadiene rubber, desirably a styrene/butadiene rubber.

In one embodiment, said functionalized diene-based elastomer is end-chain functionalized or is in-chain functionalized.

In one embodiment, at least one of said diene-based elastomers may be a tin coupled, or silicon coupled, particularly tin coupled, elastomer (e.g. styrene/butadiene elastomer). Such coupled elastomer may, for example, be used to promote a beneficial improvement (reduction) in tire treadwear and a beneficial reduction in tire rolling resistance when used in tire tread rubber compositions. Such tin coupled styrene/butadiene elastomer may be prepared, for example, by coupling the elastomer with a tin coupling agent at or near the end of the polymerization used in synthesizing the elastomer. In the coupling process, live polymer chain ends react with the tin coupling agent, thereby coupling the elastomer. For example, up to four live polymer chain ends can react with tin tetrahalides, such as tin tetrachloride, thereby coupling the polymer chains together.

The coupling efficiency of the tin coupling agent is dependent on many factors, such as the quantity of live chain ends available for coupling and the quantity and type of polar modifier, if any, employed in the polymerization. For instance, tin coupling agents are generally not as effective in the presence of polar modifiers. However, polar modifiers such as tetramethylethylenediamine, are frequently used to increase the glass transition temperature of the rubber for improved properties, such as improved traction characteristics in tire tread compounds. Coupling reactions that are carried out in the presence of polar modifiers typically have a coupling efficiency of about 50 to 60 percent in batch processes.

In cases where the tin coupled elastomer will be used in rubber compositions that are loaded primarily with carbon black reinforcement, the coupling agent for preparing the elastomer may typically be a tin halide. The tin halide will normally be a tin tetrahalide, such as tin tetrachloride, tin tetrabromide, tin tetrafluoride or tin tetraiodide. However, mono-alkyl tin trihalides can also optionally be used. Polymers coupled with mono-alkyl tin trihalides have a maximum of three arms. This is, of course, in contrast to elastomers coupled with tin tetrahalides which have a maximum of four arms. To induce a higher level of branching, tin tetrahalides are normally preferred. The tin tetrachloride is usually the most preferred.

In cases where the coupled elastomer may be used in compounds that are loaded with high levels of silica, the coupling agent for preparing the elastomer may, if desired, be a silicon halide. The silicon-coupling agents that can be used will normally be silicon tetrahalides, such as silicon tetrachloride, silicon tetrabromide, silicon tetrafluoride or silicon tetraiodide. However, mono-alkyl silicon trihalides can also optionally be used. Elastomers coupled with silicon trihalides have a maximum of three arms. This is, of course, in contrast to elastomers coupled with silicon tetrahalides during their manufacture which have a maximum of four arms. To induce a higher level of branching, if desired, of the elastomer during its manufacture, silicon tetrahalides are normally preferred. In general, silicon tetrachloride is usually the most desirable of the silicon-coupling agents for such purpose.

Such precipitated silicas may, for example, be characterized by having a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

Such precipitated silicas may, for example, also be characterized by having a dibutylphthalate (DBP) absorption value, for example, in a range of about 100 to about 400, and more usually about 150 to about 300 cc/100 g.

Various commercially available precipitated silicas may be used, such as, only for example herein, and without limitation, silicas from PPG Industries under the Hi-Sil trademark with designations 210, 243, etc., silicas from Solvay with, for example, designations of Z1165MP and Z165GR, silicas from Evonik with, for example, designations VN2 and VN3 and chemically treated precipitated silicas such as for example Agilon™ 400 from PPG Industries.

Representative examples of rubber reinforcing carbon blacks are, for example, and not intended to be limiting, those with ASTM designations of N110, N121, N220, N231, N234, N242, N293, N299, S315, N326, N330, N332, N339, N343, N347, N351, N358, N375, N539, N550, N582, N630, N642, N650, N683, N754, N762, N765, N774, N787, N907, N908, N990 and N991. Such rubber reinforcing carbon blacks may have iodine absorptions ranging from, for example, 9 to 145 g/kg and DBP numbers ranging from 34 to 150 cc/100 g.

Other fillers may be used in the vulcanizable rubber composition including, but not limited to, particulate fillers comprised of at least one of clay, exfoliated clay, graphene, metal oxides, carbon nanotubes, as well as ultra high molecular weight polyethylene (UHMWPE) and particulate polymer gels such as those disclosed in U.S. Pat. Nos. 6,242,534; 6,207,757; 6,133,364; 6,372,857; 5,395,891; or 6,127,488, and plasticized starch composite filler such as that disclosed in U.S. Pat. No. 5,672,639. One or more of such fillers, as well as other fillers, may be used in an amount ranging, for example, from about 1 to about 20 phr.

Representative of aforesaid silica coupling agents are comprised of, for example:

(A) bis(3-trialkoxysilylalkyl) polysulfide containing an average in range of from about 2 to about 4, optionally an average of from 2 to about 2.6 or from about 3.4 to about 3.8, connecting sulfur atoms in its polysulfidic bridge, or

(B) an organoalkoxymercaptosilane, or

(C) their combination.

Representative of such bis(3-trialkoxysilylalkyl) polysulfide is comprised of bis(3-triethoxysilylpropyl) polysulfide.

It is readily understood by those having skill in the art that the vulcanizable rubber composition would be compounded by methods generally known in the rubber compounding art, such as, for example, mixing various additional sulfur-vulcanizable elastomers with said diene-based elastomer containing rubber composition and various commonly used additive materials such as, for example, sulfur and sulfur donor curatives, sulfur vulcanization curing aids, such as activators and retarders and processing additives, resins including tackifying resins and plasticizers, fillers such as rubber reinforcing fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.5 to 6 phr being often preferred. Typical amounts of tackifier resins, if used, may comprise, for example, about 0.5 to about 10 phr, usually about 1 to about 5 phr. Typical amounts of processing aids comprise about 1 to about 50 phr. Additional petroleum based rubber process oils, if desired, may be added in very low levels during the blending of the rubber composition in addition to the algae rubber processing oil as the major portion of the processing oil (e.g. greater than 50 percent of the rubber processing oil) or as the only rubber processing oil. The additional petroleum based or derived rubber processing oils may include, for example, aromatic, paraffinic, naphthenic, and low PCA oils such as MEW, TDAE and heavy naphthenic, although low PCA oils might be preferred. Typical amounts of antioxidants may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr. Typical amounts of fatty acids, if used, which can include stearic acid comprise about 0.5 to about 3 phr. Typical amounts of zinc oxide may comprise, for example, about 2 to about 5 phr. Typical amounts of waxes comprise about 1 to about 5 phr. Often microcrystalline waxes are used. Typical amounts of peptizers, when used, may be used in amounts of, for example, about 0.1 to about 1 phr. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 1.5, phr. In another embodiment, combinations of a primary and a secondary accelerator might be used with the secondary accelerator being used in smaller amounts, such as, for example, from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Often desirably the primary accelerator is a sulfenamide. If a second accelerator is used, the secondary accelerator is often desirably a guanidine such as for example a diphenylguanidine, a dithiocarbamate or a thiuram compound.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The vulcanizable rubber composition containing the specialized soybean oil as a rubber processing oil may be incorporated in a variety of rubber components of an article of manufacture such as, for example, a tire. For example, the rubber component for the tire is a tread.

The pneumatic tire of the present invention may be a race tire, passenger tire, aircraft tire, agricultural tire, earthmover tire, off-the-road tire, truck tire and the like. Usually desirably the tire is a passenger or truck tire. The tire may also be a radial or bias ply tire, with a radial ply tire being usually desired.

Vulcanization of the pneumatic tire of the present invention is generally carried out at conventional temperatures in a range of, for example, from about 140° C. to 200° C. Often it is desired that the vulcanization is conducted at temperatures ranging from about 150° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following evaluative examples are presented for the purposes of illustrating and not limiting the present invention. All parts and percentages are parts by weight, usually parts by weight per 100 parts by weight rubber (phr) unless otherwise indicated.

### EXAMPLE I

In this example, the effect of using a specialized soybean oil was evaluated for use as a triglyceride based processing oil for a rubber composition as compared to petroleum based processing oil and also compared to use of triglyceride based conventional soybean oil. For this Example, the rubber compositions evaluated were a 70/30 blend of styrene/butadiene rubber (S-SBR) and high cis-polybutadiene rubber (PBD).

Comparative rubber Samples B and D contained the aforesaid conventional soybean oil.

Experimental rubber Samples A and C contained the specialized soybean oil.

The rubber Samples were prepared by mixing the elastomers with reinforcing fillers comprised of rubber reinforcing carbon black and precipitated silica together with a silica coupling agent for the precipitated silica.

For such preparation, ingredients, other than sulfur and sulfur accelerator curatives, were mixed a first non-productive mixing stage (NP1) in an internal rubber mixer for about 4 minutes to a temperature of about 160° C. The rubber composition was subsequently mixed in a productive mixing stage (P) in an internal rubber mixer with a sulfur cure package, namely sulfur and sulfur cure accelerator(s), for about 2 minutes to a temperature of about 105° C. The rubber composition is removed from its internal mixer after the non-productive mixing step and cooled to below 40° C. before the final productive mixing stage.

The basic formulation for the Comparative rubber Samples B and D and Experimental rubber Samples A and C are presented in the following Table 1 expressed in parts by weight per 100 parts of rubber (phr), with the values being rounded, unless otherwise indicated.

Formulations for Comparative rubber Sample B and Experimental rubber Sample A were the same as formulations for Comparative rubber Sample D and Experimental rubber Sample C, respectively, except for their cure packages in which a slightly higher level of curatives (slightly higher level of sulfur and accelerators) was used for Comparative rubber Sample D and Experimental rubber Sample C. On this basis, it would be expected that a higher cure level with an accompanying higher storage modulus G′ would be obtained for both of cured Comparative rubber Sample D and Experimental rubber Sample C compared to cured Comparative rubber Sample B and Experimental rubber Sample A, respectively.

TABLE 1

| | Parts by weight (phr) |
|---|---|
| Non-Productive Mixing Stage (NP1) | |
| Cis 1,4-polybutadiene rubber (PBD)¹ | 30 |
| Styrene/butadiene rubber (S-SBR)² | 70 |
| Carbon black³ | 85 |
| Specialized soybean oil⁴ | 30 or 0 |
| Conventional soybean oil⁵ | 30 or 0 |
| Zinc oxide | 2 |
| Fatty acid⁶ | 3 |
| Wax (paraffinic and crystalline) | 2 |
| Productive Mixing Stage (P) | |
| Sulfur | 1.8 and 2 |
| Sulfur cure accelerator(s)⁷ | 2.8 and 4 |

¹Cis-polybutadiene rubber as BUD1207 ™ from The Goodyear Tire & Rubber Company having a Tg (glass transition temperature) of about −102° C.
²Styrene/butadiene, solution polymerization prepared, as Solflex16S42 from The Goodyear Tire & Rubber Company having a Tg of about −42° C. and bound styrene content of about 16 percent
³N330, an ASTM designation
⁴Soybean oil triglyceride, namely a soybean plant-derived triglyceride oil comprised of saturated and unsaturated fatty acid esters with its unsaturated fatty acid ester portion comprised primarily of mono-unsaturated oleic fatty acid ester, as Plenish ™ from DuPont, comprised of about 89 percent mono-unsaturated oleic acid ester, about 8 percent linoleic acid ester and tri-unsaturation linolenic acid ester component of about 3 percent. The fatty acid esters are saturated esters such as, for example palmitic and stearic acid esters.
⁵Soybean oil triglyceride, namely a soybean plant-derived triglyceride oil comprised of saturated and unsaturated fatty acid esters with a minor portion of its unsaturated fatty acid ester being mono-unsaturated oleic fatty acid ester, as soybean oil from Cargill Dressings, comprised of about 32 percent oleic acid ester, about 68 percent poly-unsaturated fatty acid esters such as for example linoleic acid ester and linolenic acid ester. The saturated fatty acid esters are, for example palmitic and stearic acid esters.
⁶Fatty acid primarily comprised of stearic, palmitic and oleic acids
⁷Sulfenamide and diphenylguanidine sulfur cure accelerators

The following Table 2 illustrates cure behavior and various physical properties of rubber Comparative rubber Samples B and D (containing conventional soybean oil), and Experimental rubber Samples A and C (containing specialized soybean oil) based upon the basic formulation of Table 1. Where cured rubber samples are examined, such as for the toughness and hot rebound values, the rubber samples were cured for about 14 minutes at a temperature of about 160° C.

TABLE 2

| | Parts (phr) | | | |
|---|---|---|---|---|
| | Exp. A | Comp. B | Exp. C | Comp. D |
| Materials | | | | |
| Polybutadiene rubber | 30 | 30 | 30 | 30 |
| Styrene/butadiene rubber | 70 | 70 | 70 | 70 |
| Carbon black | 85 | 85 | 85 | 85 |
| Specialized soybean oil | 30 | 0 | 30 | 0 |
| Conventional soybean oil | 0 | 30 | 0 | 30 |
| Sulfur | 1.8 | 1.8 | 2 | 2 |
| Sulfur cure accelerators | 2.8 | 2.8 | 3 | 3 |
| Processing Uncured Rubber | | | | |
| Storage modulus (G′), 0.83 | 178 | 177 | 174 | 174 |
| HZ, 100° C., 15% strain | | | | |
| (MPA) | | | | |
| Cure Data | | | | |
| Minimum torque, dNm | 1.6 | 1.6 | 1.6 | 1.6 |
| Maximum torque, dNm | 9.8 | 9 | 10.3 | 9.7 |
| Delta torque, dNm | 8.2 | 7.5 | 8.7 | 8.1 |
| T90, minutes | 6.5 | 6.4 | 6.1 | 5.8 |
| RPA Dynamic Property, | | | | |
| Cured Rubber, 100° C., | | | | |
| 11 Hz, 15% strain | | | | |
| Storage modulus (G′), kPa | 1424 | 1297 | 1494 | 1380 |
| Tan delta, 15% strain | 0.14 | 0.16 | 0.14 | 0.15 |
| Tensile Properties, Room | | | | |
| Temperature | | | | |
| Modulus, 100%, kPa | 3.2 | 2.7 | 3.5 | 2.9 |
| Modulus, 300%, kPa | 12.7 | 10.6 | 13.9 | 11.9 |
| Tensile strength, MPa | 15.9 | 16 | 15 | 15.6 |
| Elongation at break, (%) | 373 | 443 | 326 | 391 |

As seen in Table 2, the results show the benefit of use of the specialized soybean oil in Experimental rubber Samples A and C, when used instead of the conventional soybean oil in Comparative rubber Samples B and D.

It is observed that that the storage modulus (G′) values of 1424 and 1494 kPa, respectively, for cured Experimental rubber Samples A and C, respectively, which contained the specialized soybean oil, are higher than that the storage modulus (G′) values of 1297 and 1380 kPa, respectively, for cured Comparative rubber Samples B and D, respectively, which contained the conventional soybean oil.

It is considered that the higher storage modulus (G′) values for the Experimental rubber Samples A and C are an indication beneficially better tire handling performance for tires having treads of such rubber compositions containing the specialized soybean oil.

It can be also seen in Table 2 that the tan delta values of 0.14 for cured Experimental rubber Samples A and C, which contained the specialized soybean oil, are beneficially lower than that the tan delta values of 0.16 and 0.15, respectively, for cured Comparative rubber Samples B and D, respectively, which contained the conventional soybean oil.

It is considered that the lower tan delta values are an indication of lower hysteresis properties of the Experimental rubber Samples A and C which, in turn, is an indication of beneficially lower internal heat generation of the rubber composition for a tire component (e.g. tire tread) as well as predictably beneficially lower rolling resistance for a tire with tread of such rubber composition.

Therefore, it is concluded that this evaluation has successfully demonstrated a beneficial and significant discovery of use of specialized soybean oil with its significantly lower unsaturation content (significantly higher mono-unsaturation oleic acid ester component content) instead of the more conventional soybean oil with its significantly higher unsaturation content (significantly higher linoleic acid and linolenic component content).

While certain representative embodiments and details have been shown for the purpose of illustrating the subject invention, it will be apparent to those skilled in this art that various changes and modifications can be made therein without departing from the scope of the subject invention.

1. A tire having a tread of rubber composition comprised of, based on parts by weight per 100 parts by weight of elastomer (phr):
(A) at least one conjugated diene-based elastomer comprised of at least one of cis 1,4-polyisoprene, cis 1,4-polybutadiene, isoprene/butadiene, styrene/isoprene, styrene/butadiene and styrene/isoprene/butadiene elastomers,
(B) from about 5 to about 60 phr of triglyceride ester based specialized soybean oil comprised of saturated and unsaturated fatty acid esters, where its unsaturated fatty acid esters are comprised of a combination of mono-unsaturated oleic acid ester, di-unsaturated linoleic acid and tri-unsaturated linolenic acid esters wherein said unsaturated fatty acid esters are comprised of about 75 to about 95 percent mono-unsaturated oleic acid ester, wherein said combination of saturated and unsaturated fatty acids contain from about 65 to about 90 percent mono-unsaturated oleic acid ester, wherein said tri-unsaturated linolenic acid ester comprises at least 1 percent of said fatty acid esters,
(C) from about 30 to about 140 phr of reinforcing filler comprised of:
(1) rubber reinforcing carbon black, or
(2) combination of rubber reinforcing carbon back and precipitated silica,
wherein silica coupling agent is provided for said precipitated silica having a moiety reactive with hydroxyl groups on said precipitated silica and another different moiety interactive with said diene-based elastomer(s),
wherein said silica coupling agent is comprised of.
(a) bis(3-trialkoxysilylalkyl) polysulfide containing an average in range of from about 2 to about 4 connecting sulfur atoms in its polysulfidic bridge,
(b) an organoalkoxymercaptosilane, or
(c) their combination.

2. (canceled)

3. The tire of claim 1 wherein said precipitated silica is a precipitated silica hydrophobated by reaction in situ within the rubber composition with said silica coupling agent.

4. The tire of claim 1 wherein said precipitated silica is a pre-hydrophobated precipitated silica by a reaction of precipitated silica with said silica coupling agent to form a composite thereof prior to its addition to the rubber composition.

5. The tire of claim 3 where said precipitated silica is a pre-hydrophobated precipitated silica, wherein additional silica coupler is added to the rubber composition.

6. The tire of claim 3 where said precipitated silica is a pre-hydrophobated precipitated silica, wherein additional precipitated silica is added to the rubber composition.

7. The tire of claim 1 wherein said rubber composition is free of petroleum based rubber processing oil.

8. (canceled)

9. The tire of claim 1 wherein said reinforcing filler is comprised of a combination of rubber reinforcing carbon black and precipitated silica and wherein at least one of said diene based elastomers is a functionalized styrene/butadiene elastomer or functionalized cis 1,4-polybutadiene elastomer containing at least one functional group reactive with hydroxyl groups contained on the precipitated silica reinforcing filler wherein said functional group is comprised of at least one of amine, siloxy, carboxyl, hydroxyl groups, and thiol groups.

10. The tire of claim 9 wherein said functionalized diene-based elastomer is a functionalized styrene/butadiene elastomer which is end-chain functionalized or is in-chain functionalized with at least one of amine, siloxy, thiol and carboxyl groups reactive with hydroxyl groups of said precipitated silica.

11. The tire of claim 1 wherein at least one of said diene-based elastomers is a tin or silicon coupled styrene/butadiene elastomer.

12. (canceled)

13. The tire of claim 1 wherein the reinforcing filler is comprised of a combination of rubber reinforcing carbon black and precipitated silica.

14. (canceled)

15. The of claim 1 wherein said coupling agent is comprised of a bis(3-triethethoxysilylpropyl) polysulfide having an average of from about 2 to about 2.6 or from about 3.4 to about 3.8 connecting sulfur atoms in its polysulfidic bridge.

16. (canceled)

17. (canceled)

18. (canceled)

19. (canceled)

20. (canceled)
